(19) United States
(12) Patent Application Publication
(10) Pub. No.: US 2003/0045283 A1
(43) Pub. Date: Mar. 6, 2003

(54) Bluetooth enabled hearing aid

(76) Inventor: Johan Jan Hagedoorn, Enschede (NL)

Correspondence Address: Ronald L. Grudziecki, BURNS, DOANE, SWECKER & MATHIS,L.L.P., P.O. Box 1404, Alexandria, VA, 22313-1404, US

(21) Appl. No.: 09/946,603

(22) Filed: Sep. 6, 2001

(51) Int. Cl. H04Q 7/20

(52) U.S. Cl. 455/426; 455/41; 455/557

(57) ABSTRACT

Apparatus and methods for providing a link between the hearing aid of a user and the user's wireless telephone to reduce interference in the hearing aid due to transmissions of the wireless telephone. The link between the wireless telephone and the hearing aid is formed using an ad hoc polling based communication infrastructure, such as the Bluetooth protocol.

### FIELD OF THE INVENTION

The present invention pertains to hearing aids and wireless telephones. In particular, the present invention involves apparatus and methods for reducing the interference experienced by a person wearing a hearing aid when using a wireless telephone.

### BACKGROUND

Cellular telephones continue to gain acceptance, becoming increasingly more widespread each year. Cellular telephone usage is already quite common in Europe, North America, and all industrialized regions across the globe. Cellular systems are being implemented in a number of less developed nations as well. In fact, some less developed countries have leapfrogged over the development of a capital-intensive landline communication infrastructure, and instead installed cellular telephone networks as their primary communication systems.

As the popularity of cellular telephony increases, more and more people rely on cellular telephones for their communication needs. Most cellular users are able to enjoy the convenience and versatility of placing mobile telephone calls with no more difficulty than using conventional landline telephones. There are some people, however, who have hearing impairments which prevent them from fully enjoying the benefits of wireless communication. In particular, people who use hearing aids often experience difficulty in using cellular telephones due to RF electromagnetic compatibility (EMC) effects.

The problems of interference between cellular telephones and hearing aids are described in further detail in the present assignee's U.S. Pat. No. 6,122,500 to Paul Dent et al., the contents of which are incorporated by reference herein, in their entirety. The problem of cellular telephone interference addressed in the '500 patent arises when a mobile phone is operated near sound reproducing equipment that is not designed for operation in close proximity to radio transmitters. Such usage results in interference, e.g., an audible buzz, in hearing aids and high-fidelity equipment is due to the cellular telephone's transmitter pulse repetition rate being spuriously detected. This effect occurs when the cordless phone is extremely close to such equipment, for example, within three feet or less, which is the case when a phone is placed next to the hearing aid of a hearing impaired subscriber.

### SUMMARY

In addition to the aforementioned problems due to interference, other problems exist for hearing aid wearers who use cellular telephones. For example, it is often difficult for a person wearing a hearing aid to hear a cellular telephone in a moving car, due to the ambient sounds of traffic and background noise. Conventional attempts to address the car noise problems using handsfree car kits are not satisfactory for hearing aid wearers. For example, handsfree car kits or automobile docking stations generally do not work well for hearing aid users because the speakers tend to be too far away from the user to overcome the ambient noise problems. The aforementioned '500 patent to Dent et al., entitled “Cordless Time-Duplex Phone with improved Hearing-Aid Compatible Mode,” provides solutions which aptly overcome the aforementioned problems. The present invention provides further solutions for overcoming these and other disadvantages by creating a low power communication link between the cellular handset and the hearing aid.

The present invention involves apparatus and methods for establishing an ad hoc communication link between a wireless communication system and a hearing aid. In accordance with exemplary embodiments, a limited access piconet, consisting of a mobile station and a hearing aid, is formed using an ad hoc polling based communication infrastructure such as the Bluetooth protocol. Upon detecting a wireless telephone call, the mobile station polls for the presence of the hearing aid. If the hearing aid is present, the communication link is establish between the wireless communication system and the hearing aid via the mobile station. The hearing aid's speaker is used to produce the audio from the incoming caller based upon signals transmitted via said communication link.

### BRIEF DESCRIPTION OF THE DRAWINGS

The objects, features and advantages of the present invention will become more readily apparent to those skilled in the art upon reading the following detailed description, in conjunction with the appended drawings, in which:

FIG. 1 depicts an exemplary apparatus in accordance with the present invention for linking a mobile station to a Bluetooth enabled hearing aid via a Bluetooth link;

FIG. 2 depicts a flow chart of a method for communicating between a Bluetooth hearing aid and a mobile station, in accordance with the present invention; and

FIG. 3 depicts exemplary hearing aid configurations which may be used in accordance with the present invention.

### DETAILED DESCRIPTION

In accordance with the present invention, Bluetooth is used to provide a communication link between a user's mobile station and hearing aid, thus preventing interference between the devices. Said interference is diminished/prevented by preserving a physical distance between the hearing aid and the user's mobile station. Bluetooth is a polling based communication infrastructure often used for short-range transmission of digital data between desktop devices and mobile communication devices (e.g., laptops, PDAs, phones). Bluetooth is further described in the Bluetooth Baseband Specification 1.1 by the Bluetooth Special Interest Group (SIG), which is incorporated herein by reference in its entirety. Of a historical note, the name “Bluetooth” is derived from the 10th century King of Denmark, Harald Blatand, alias Bluetooth, who introduced Christianity to Denmark.

Bluetooth offers a number of advantages over conventional wireless technologies. Unlike conventional infrared data transmission techniques which require line-of-sight between devices, Bluetooth uses omnidirectional radio waves that can transmit through walls and other non-metal barriers. Since line of sight is not required for a Bluetooth link, a hearing aid wearer using the present invention can put their mobile station into their pocket, have it attached to their clothing or belt, or leave it lying on their desk, automobile dashboard or other convenience place, for the duration of a call.

Bluetooth systems operate in the unlicensed 2.4 GHz Industrial-Scientific-Medical (ISM) band using a frequency hopping scheme. The hopping is performed on 79 RF channels spaced 1 MHz apart using a frequency hopping spread spectrum technique that changes its signal 1600 times per second. The Bluetooth system provides full-duplex transmission based on slotted Time Division Duplex (TDD) scheme, where each slot is 0.625 ms long. Bluetooth provides considerable data transfer capability at short ranges. For example, Bluetooth devices typically transfer up to 720 Kbps standard Bluetooth ranges of 10 meters and up to 100 meters with a power boost.

An exemplary Bluetooth piconet is a collection of two or more devices connected in an ad hoc fashion. Bluetooth piconets are ad hoc in the sense that Bluetooth units are free to enter and leave under the direction of a master unit, as opposed to being fixed networks. Because Bluetooth piconets are ad hoc with units freely entering and leaving, Bluetooth links have not heretofore been used in hearing aid applications. The present invention uses Bluetooth to connect a cellular telephone to a hearing aid. Exemplary embodiments of the present invention using a Bluetooth link to connect a hearing aid are ad hoc in the sense that a particular mobile station can be configured to communicate with any of several hearing aids. Additionally, a particular hearing aid can be arranged for use with more than one mobile station. However, exemplary embodiments of the present invention preferably use a limited access ad hoc network, for security and privacy reasons. In these embodiments, limited access is achieved by storing the hearing aid's Bluetooth address in the hearing aid user's cell phone. In other embodiments, access is limited by simply using a reduced power transmitter in the hearing aid, a feature which also advantageously reduces the battery size within the hearing aid.

At least one device in each piconet acts as the master, and the other devices act as slaves. A piconet used in accordance with the present invention preferably has two nodes, that is, one master node and one slave node. The master node's clock and hopping sequence are used to sequence the slave nodes in a piconet. It should be noted that the terms “master” and “slave” are logical states, in that a particular Bluetooth device has the role of either a master or a slave, depending on how the piconet is set up. In exemplary preferred embodiments, the mobile station is the master and the hearing aid is the slave. These roles can be reversed in alternative embodiments.

Data can be transmitted in Bluetooth packets containing either synchronous data or asynchronous data. Synchronous data, often used for voice traffic, can be transmitted via Synchronous Connection Oriented (SCO) links. Asynchronous data can be transmitted via Asynchronous Connectionless Links (ACL). Depending on the type of packet being used (e.g., not for SCO packets transferring synchronous data), an acknowledgment and retransmission scheme is used to ensure reliable data transfer and provide forward error correction (FEC) in the form of channel coding.

Each Bluetooth unit has a globally unique 48 bit IEEE 802 address. This address, called the Bluetooth Device Address (e.g., BD_ADDR) is initially assigned at the time the Bluetooth unit is manufactured. In addition, the Master of a piconet assigns a local active member address (e.g, AM_ADDR) to each active member of the piconet. The AM_ADDR, which is only three bits long, is dynamically assigned and deassigned whenever a new connection is established or released, respectively. The AM_ADDR is unique only within a single piconet. The master uses the AM_ADDR when polling a slave in a piconet. However, when the slave, triggered by a packet from the master addressed with the slave's AM_ADDR, transmits a packet to the master, it includes its own AM_ADDR (not the master's) in the packet header.

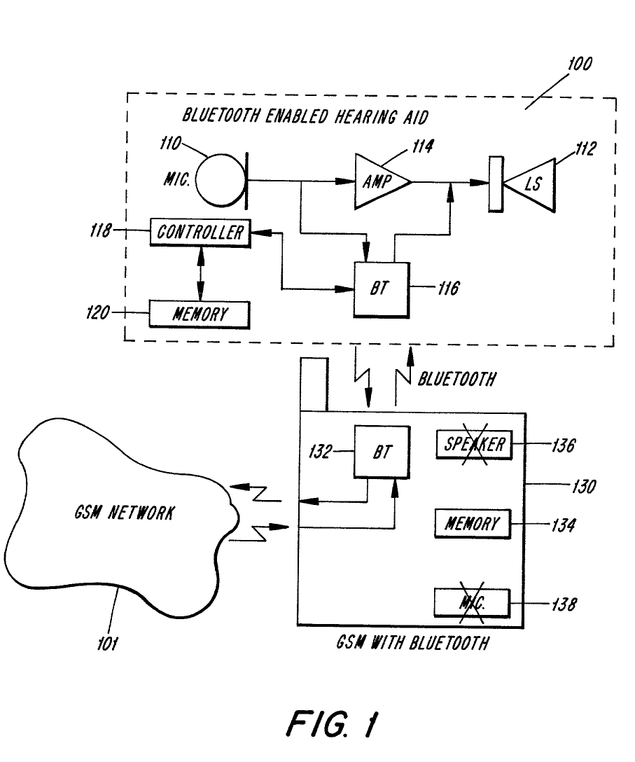

FIG. 1 depicts an exemplary apparatus in accordance with the present invention for linking a mobile station to a Bluetooth enabled hearing aid via a Bluetooth link. The hearing aid 100 is linked via Bluetooth to mobile station 130 in order to send and receive telephone signals of the wireless network 101. The wireless network 101, in turn, is connected to the public switched telephone network (PSTN). As shown in the figure, the hearing aid 100 includes a microphone 110, a speaker 112, amplifier circuitry 114, Bluetooth circuitry 116, a controller 118, and a memory 120. The microphone 110 picks up sounds, which are amplified or processed and radiated into the user's ear by the speaker 112. The components of hearing aid 100 can be arranged as shown in FIG. 1, or in another like manner suitable for amplifying or processing received sounds to assist a person with impaired hearing. The hearing aid 100 can be either an inner ear model or a wraparound-type model which fits behind a user's ear.

Exemplary embodiments of the Bluetooth circuitry 116 contained in the hearing aid 100 contain a low power transmitter. For in-the-ear configurations of the present invention, the low powered transmitter in the Bluetooth circuitry 116 enables the device to be sufficiently miniaturized, so as to be contained comfortably in the shell of a user's ear. The low power link also aids in limiting unauthorized access since other receivers are not likely to be within the small transmission range. For example, some embodiments of the present invention comprise Bluetooth circuitry 116 containing a transmitter with one-half the standard range transmit power of ordinary Bluetooth transmitters. The transmit power of ordinary Bluetooth transmitters is 1.0 mW for a standard range of 10 meters, while other Bluetooth transmitters with a booster have a transmit power of 10 mW for a range of 100 meters. In other embodiments, the transmitter contained in Bluetooth circuitry 116 has an output power of 0.1 mW, while in yet other embodiments an output power of 0.3 mW, or other like output power values, is used. Alternatively, the transmitter may be specified in terms of its transmit range (e.g., a transmitter having a range of 3 meters). In addition to having a transmitter, the Bluetooth circuitry 116 also contains a receiver disposed to receive Bluetooth signals from the mobile station 130. The Bluetooth circuitry 132 in the mobile station 130 has a normal transmit power, in accordance with exemplary embodiments of the present invention.

The Bluetooth enabled hearing aid 100 contains hearing aid circuitry including a microphone 110, amplifier circuitry 114 and speaker circuitry 112. The microphone 110 picks up sounds, which are then amplified or otherwise processed, and provides the sounds via speaker 112 at a level suitable for a user with impaired hearing. The controller 118 is disposed so as to control operation of the hearing aid and operation of the Bluetooth circuitry 116. The controller 118 is in electrical communication with a memory 120 which can store, among other things, the Bluetooth address and authorization information for ensuring the privacy of the Bluetooth link between the hearing aid 100 and the mobile station 130. For example, the memory 120 can be programmed to contain the Bluetooth device address of the associated mobile station 130. It should be mentioned that the Bluetooth device address, BD_ADDR, of the Bluetooth enabled hearing aid 100 itself is normally stored within the Bluetooth circuitry 116, but may be stored in another memory such as the memory 120.

The mobile station 130 is configured to communicate with the wireless network 101 via a wireless communication link (e.g., cellular telephone link), as understood by those of skill in the art. In addition to containing Bluetooth circuitry 132, exemplary embodiments of the mobile station 130 also contain a memory 134 for storing the Bluetooth device address of the associated Bluetooth enabled hearing aid 100. These exemplary embodiments in which each device stores the corresponding Bluetooth device's address ensure that the Bluetooth link between the hearing aid to the mobile station is secure. Other aspects of various embodiments of the present invention ensure that a secure Bluetooth link is maintained; e.g., encryption of the Bluetooth SCO channel, reduced range, frequency hopping, and only the subscribed hearing aid or mobile station can set up a link.

The mobile station 130 comprises a speaker 136 for radiating audio (e.g., an incoming caller's voice) and a microphone 138 for picking up sound (e.g., the mobile station user's voice). In accordance with one embodiment of the present invention, the mobile station 130 has both its speaker 136 and its microphone 138 disabled. Instead, the speaker 112 and microphone 110 of the Bluetooth enabled hearing aid 100 are used for communicating with the wireless network. In accordance with another embodiment, the mobile station 130 has only its speaker 136 disabled. In this embodiment the speaker 112 of the Bluetooth enabled hearing aid 100 is used, in conjunction with the microphone 138 of the mobile station, for communicating with the wireless network with the path between the mobile station 130 and the hearing aid 100 provides only the downlink portion of the communication link from the wireless network 101.

In exemplary embodiments of the invention, either the Bluetooth enabled hearing aid 100 or the mobile station 130 can contain, or be linked with, an intermediate device. The intermediate device can be located either within the case of the hearing aid 100 or the mobile station 130, or can be connected as an add-on peripheral device. Intermediate devices for use in the present invention include a realtime translator, voice equalizer, or like type of audio processing circuitry.

In other embodiments, one or both of the speaker 136 or microphone 138 can be operative (i.e., not disabled) while the speaker 112, or the speaker 112 and microphone 110, of the Bluetooth enabled hearing aid 100 are used to complete the communications link. For example, in one such embodiment the speaker 136 of mobile station 130 may be operative to produce voice from a calling party while at the same time the speaker 112 of the hearing aid produces the caller's voice as well. In this way, a hearing aid user engaged in a Bluetooth linked mobile phone call could hand the phone to another person to speak, without requiring that person to move out of Bluetooth range.

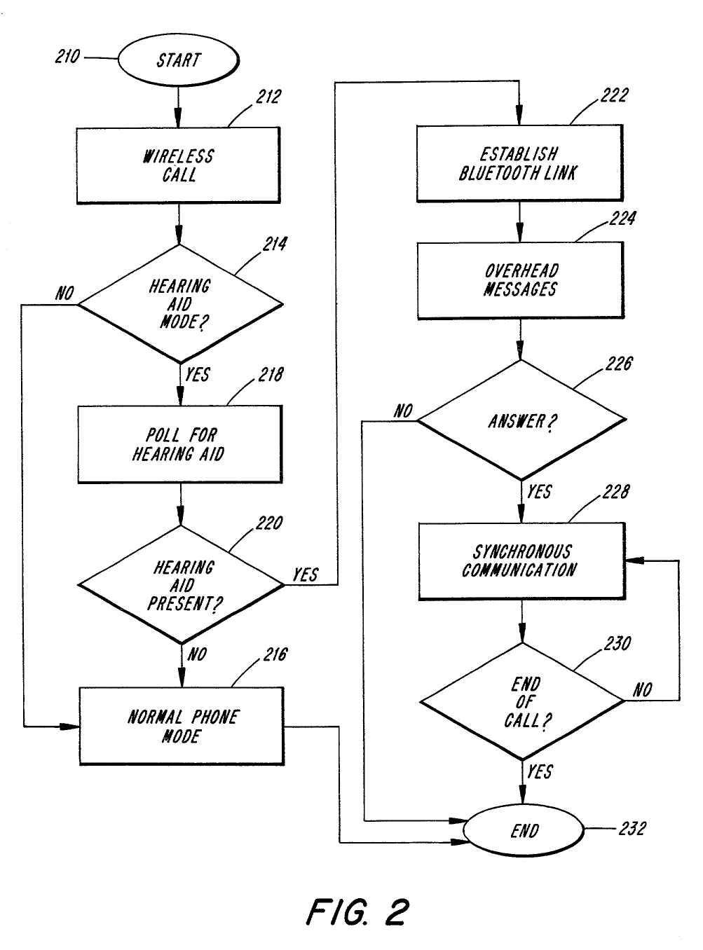

FIG. 2 depicts a flow chart of a method for communicating wirelessly by establishing a communication link between a Bluetooth hearing aid and a mobile station, in accordance with the present invention. The method begins in step 210 and proceeds to step 212. In exemplary embodiments of the present invention, a piconet has been previously formed between the mobile station and one or more hearing aids prior to performing step 212. That is, the piconet has been formed (e.g., address, registration and other status information has been exchanged) before calls are received or sent, although the slave Bluetooth unit may be dormant until a call is received or sent. In step 212, a wireless call is either received by the mobile station, or the user manipulates the mobile station to send a wireless call. The method proceeds from step 212 to step 214.

Step 214 is performed next to ascertain whether the mobile station is in a hearing aid mode. In some embodiments the mobile station is always in a hearing aid mode, and therefore, step 214 may be omitted. If the equipment is configured to perform step 214 and it is determined that the call is not in a hearing aid mode, the method proceeds in accordance with the “NO” branch from step 214 to 216, to perform a conventional wireless telephone call. If, in step 214, it is determined that the wireless call is being conducted in the hearing aid mode, the method proceeds in accordance with the “YES” branch to step 218.

In step 218 the mobile station polls to see if the Bluetooth enabled hearing aid is listening. In some embodiments, the piconet including the master node mobile station and a slave node hearing aid may be said to be pre-formed but dormant until a cellular call is received, and then the master polls the slave. The forming of a piconet can be completed faster by establishing a pre-formed link, and putting it in the park mode. If the wireless call of step 212 is an incoming call, the polling step 218 is performed in response to receiving the incoming call. On the other hand, if, in step 212 the call is an outgoing call, the polling step is initiated in response to the user dialing a telephone number so that the user can hear the telephone number being dialed. After performing step 218, the method proceeds to step 220 where it is determined whether a Bluetooth enabled hearing aid is present and receives the polling message sent in step 218. If no hearing aid is present to answer the polling message, the method proceeds in accordance with the “NO” branch from step 220 to step 216 and a normal landline telephone communication is executed. If a hearing aid is present and answers the polling message of step 218, the method proceeds in accordance with the “YES” branch from step 220 to step 222.

In step 222 a Bluetooth link is established between the Bluetooth enabled hearing aid 100 and the mobile station 130. In one preferred embodiment of the present invention, the link between the Bluetooth enabled hearing aid 100 and the mobile station 130 is formed as a limited access ad hoc piconet with the mobile station 130 acting as the master and the Bluetooth enabled hearing aid 100 acting as the sole slave of the piconet. The method proceeds to step 224 in which an overhead message is sent from the mobile station 130 to the hearing aid 100, the overhead message including a ring signal. If the call is an incoming call, then the ring signal of step 224 produces audio signals to sound like a telephone ringing in the hearing aid. If the call is an outgoing call, the ring signal produces audio which sounds like ringing at the other end of the connection. In some embodiments, during the call, either comfort noise or a periodic comfort beep sound, can be provided on the hearing aid user's end to avoid a connection having dead silence which could be mistaken for a dropped call.

In some exemplary embodiments of the present invention, a buzzer (e.g., a ringer) of the mobile station 130 is enabled during the ring signal of step 224. In this way, others aside from the hearing aid wearer can hear the buzzer of the mobile station 130 ringing. In alternative embodiments, the buzzer is disabled, and a ring signal is reproduced in the speaker 112 of the hearing aid so only the hearing aid wearer can hear the ringing sound in his hearing aid. After the overhead messaging of step 224, the method proceeds to step 226 where it is determined whether the incoming call or the outgoing call has been answered. If the call was not answered, the method proceeds in accordance with the “NO” branch to step 232 and ends. If the call is answered, either by the other party being called (in the case of an outgoing call) or by the hearing aid wearer (for an incoming call), then the method proceeds in accordance with the “YES” branch to step 228.

In step 228, a Bluetooth link has been established and the telephone conversation is conducted by transferring data between the mobile station 130 and the Bluetooth enabled hearing aid 200. Preferred embodiments use a synchronous link to exchange packet data, while alternative embodiments can exchange data asynchronously. The method proceeds to step 230 in which it is determined whether the end of the call has been reached, i.e., a hook-ring signal or power off signal is detected. While the telephone call is ongoing, the method loops back in accordance with the “NO” branch from step 230 to step 228 to continue the synchronous communication. When the telephone call ends, the method proceeds in accordance with the “YES” branch to step 232 where the method ends.

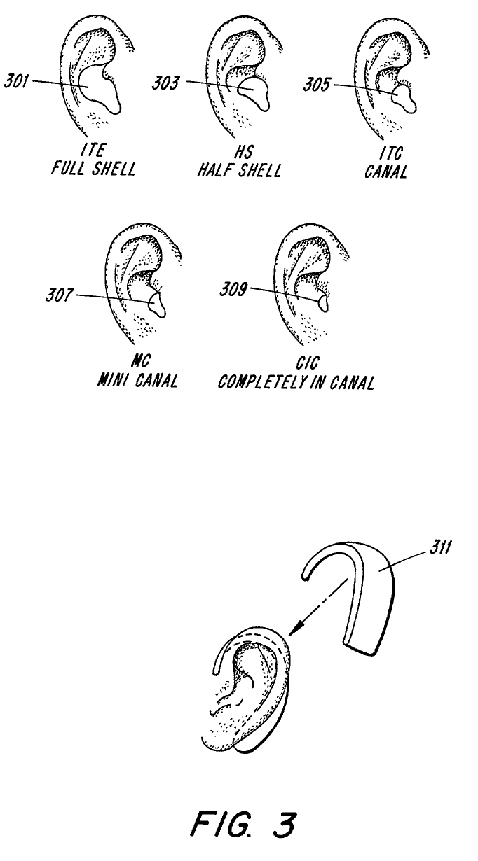

FIG. 3 depicts exemplary hearing aid configurations which may be used in accordance with the present invention. The six exemplary hearing aid configurations shown in the figure include a full-shell (or in-the-ear) configuration 301, a half shell configuration 303, a canal configuration 305, a mini canal configuration 307, a completely-in-canal configuration 309 and an over-the-ear (or clip on) configuration 311. Other like configurations may be used with the present invention, as well. As shown in the figure, the completely-in-canal configuration 309 is smaller than the remaining configurations, with the full-shell configuration 301 being the largest of the configurations shown which are contained within the shell of the user's ear.

In exemplary embodiments, the present invention uses a microphone to communication wirelessly via a mobile station, with the microphone being contained substantially in the shell of the hearing aid user's ear. For example, in configurations 301-309, the microphone is substantially contained in the shell of an ear in that it does not extend outward beyond the ear of the user (that is, does not extend in a direction perpendicular the figure). Regarding the over-the-ear configuration 311, exemplary embodiments of the configuration 311 do not extend forward, towards the user's face, beyond the user's ear. In this respect, the present invention differs from conventional hands-free headsets which have a microphone extending around the user's face to a position proximate the mouth.

Some exemplary embodiments of the present invention are drawn to a hearing aid-type hands-free wireless telephone, the ear-mount telephone. The ear-mount telephone is similar in appearance to a hearing aid, but the ear-mount telephone is configured for use by those who do not have impaired hearing. For example, the less expensive embodiments of the ear-mount telephone do not have audio frequency processing capabilities to tailor sounds for a person who cannot hear particular frequencies, e.g., due to ear injuries or hearing impairments. The ear-mount telephone embodiment of the present invention is substantially the same shape and weight as a hearing aid, and, as such, can be placed within, or clipped behind, a user's ear. The ear-mount telephone is linked, via a Bluetooth link, to a mobile station which, in turn, is connected to the PSTN via a wireless communication system.

Although the present invention has been described in connection with Bluetooth networks and protocols, it will be recognized that the present invention is applicable to other types of ad hoc networks, and with like types of protocols. For example, the present invention can be used in types of network in which a node participates on a time division duplex basis between more than one network.

For ease of illustration the present invention has been described in terms of communication with a Global System for Mobile Communication (GSM) network. The present invention may be practiced in any wireless or cellular telecommunication network, including but not limited to ther time division multiple access (TDMA) systems, code division multiple access (CDMA) systems, cordless telephone devices, wireless PBX systems, or other like wireless systems or protocols. A mobile station, as disclosed in this specification, may be a wireless device such as a cellular or cordless telephone, or may be a type of audio playback device such as recording or amplification equipment connected to the hearing aid via an ad hoc piconet.

The present invention has been described with reference to several exemplary embodiments. However, it will be readily apparent to those skilled in the art that it is possible to embody the invention in specific forms other than those of the exemplary embodiments described above. This may be done without departing from the present invention. The Bluetooth mechanism described herein is one of the applied techniques featuring a piconet-like network, and is used as an example. Other techniques, deploying the Bluetooth characteristics, can be used in accordance with the present invention as well.

The exemplary embodiments disclosed herein are merely illustrative and should not be considered restrictive in any way. The scope of the invention is given by the appended claims rather than the preceding description, and all variations and equivalents which fall within the range of the claims are intended to be embraced therein.

1. A method of establishing a communication link between a wireless communication system and a hearing aid, the method comprising steps of:
forming a limited access piconet using an ad hoc polling based communication infrastructure, the piconet comprising a mobile station and a hearing aid;
detecting a wireless call;
polling by the mobile station for the presence of the hearing aid; and
establishing the communication link between the wireless communication system and the hearing aid via the mobile station;
wherein a speaker of the hearing aid is used to produce audio based upon signals transmitted via said communication link.

2. The method of claim 1, further comprising steps of:
picking up speech of a user of the hearing aid with a microphone of the hearing aid; and
transmitting via the communication link, from the hearing aid to the mobile station, signals representing said speech.

3. The method of claim 1, further comprising steps of:
picking up speech of a user of the hearing aid with a mobile station microphone.

4. The method of claim 2, wherein the microphone of the hearing aid and the speaker of the hearing aid are both disposed to fit substantially within a shell of the user's ear.

5. The method of claim 1, wherein the wireless call is an outgoing wireless call.

6. The method of claim 1, wherein the wireless call is an incoming wireless call.

7. The method of claim 1, wherein a speaker of the mobile station is disabled.

8. A method of establishing a communication link between a wireless communication system and a hearing aid, the method comprising steps of:
forming a limited access piconet using an ad hoc polling based communication infrastructure, the piconet comprising a mobile station and a hearing aid;
designating the mobile station as a master node and the hearing aid as a slave node of the piconet;
polling by the mobile station for the presence of the hearing aid;
establishing the communication link from the wireless communication system to the hearing aid via the mobile station; and
wherein the hearing aid comprises a microphone and a speaker both disposed to fit substantially within in a shell of a user's ear.

9. The method of claim 8, further comprising steps of:
storing a unique device address of the hearing aid in a memory of the mobile station; and
limiting access to the piconet by using the unique device address as an identifier for access.

10. The method of claim 8, wherein the step of polling is performed in response to a step of detecting a wireless call.

11. The method of claim 8, further comprising:
sending an overhead message from the mobile station to the hearing aid.

12. The method of claim 11, wherein the wireless call is an outgoing call from the mobile station through the wireless communication system, the method further comprising a step of:
producing, in the hearing aid, either a first sound representing a ringing of another mobile station being called or a second sound representing a busy signal.

13. The method of claim 12, wherein the sound is produced in response to the overhead message.

14. The method of claim 8, wherein the wireless call is an incoming call from the wireless communication system, the method further comprising a step of:
ringing by the mobile station.

15. The method of claim 8, wherein the wireless call is an incoming call from the wireless communication system to the mobile station, the method further comprising a step of:
emulating, in the hearing aid, a sound of the mobile station ringing based upon the overhead message.

16. The method of claim 8, wherein the communication link carries signals in a first direction from the wireless communication system to the hearing aid and in a second direction from the hearing aid to the wireless communication system.

17. The method of claim 8, wherein the ad hoc polling based communication infrastructure is a Bluetooth network.

18. A hearing aid apparatus for communicating via a wireless communication system, the apparatus comprising:
a transmitter disposed to transmit signals from the hearing aid to a mobile station;
means for establishing a communication link between by forming a limited access ad hoc polling based communication infrastructure, the piconet comprising a hearing aid and a mobile station; and
a speaker disposed within the hearing aid;
wherein speech signals from said wireless communication are conveyed via the speaker disposed within the hearing aid.

19. The apparatus of claim 18, further comprising:
a microphone, wherein both the microphone and the speaker are disposed to fit substantially within in a shell of a user's ear.

20. The apparatus of claim 19, wherein the mobile station is designated as a master node and the hearing aid is designated as a slave node of the piconet.

21. The apparatus of claim 19, wherein the transmitter has an output power of 0.5±0.1 mW.

22. The apparatus of claim 19, wherein the transmitter has an output power of 0.1±0.05 mW.
